(19) United States
(12) Patent Application Publication
(10) Pub. No.: US 2010/0103146 A1
(43) Pub. Date: Apr. 29, 2010

(54) CYCLING THROUGH DISPLAY INPUT PORTS

(76) Inventor: William H. Prince, Hockley, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/259,565

(22) Filed: Oct. 28, 2008

(51) Int. Cl. G06F 3/038

(52) U.S. Cl. 345/204

(57) ABSTRACT

A system comprises first ports that receive input signals and one or more second ports that do not receive input signals. The system also comprises storage comprising a data structure in which the first and second ports are ordered by priority. The system further comprises processing logic that, when selecting an input signal to provide to a display, cycles through the first and second ports in the order. When cycling through the ports, the processing logic provides input signals from the first ports to the display and skips over the second ports.

### BACKGROUND

Computer systems generally comprise displays. A display may contain multiple ports that are capable of receiving display input signals. For example, a port may receive a video input signal from another part of the computer system, such as a chassis that houses processing logic, video cards, etc. The end-user of the computer system is typically required to use a button or other mechanism to cycle through each of the multiple ports until a desired input signal is found. Cycling through each of the ports in this manner consumes undesirably large amounts of time.

### BRIEF DESCRIPTION OF THE DRAWINGS

For a detailed description of exemplary embodiments of the invention, reference will now be made to the accompanying drawings in which:

FIG. 1 shows an illustrative system implementing the techniques disclosed herein, in accordance with embodiments;

FIG. 2 shows a detailed view of a display of the system of FIG. 1, in accordance with embodiments;

FIGS. 3-4 show illustrative data structures stored on the display of FIG. 2, in accordance with embodiments; and

FIG. 5 shows a flow diagram of an illustrative method implemented in accordance with embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique by which the amount of time spent cycling through multiple display ports is reduced. In particular, the technique includes detecting which of multiple display input ports receive input signals, storing identifiers associated with the detected input signals to a data structure, and subsequently using the data structure to cycle through only those ports that have been identified as receiving an input signal. Display input ports that are not currently receiving active input signals are skipped during the cycling process. In this way, the amount of time spent cycling through the ports is substantially reduced.

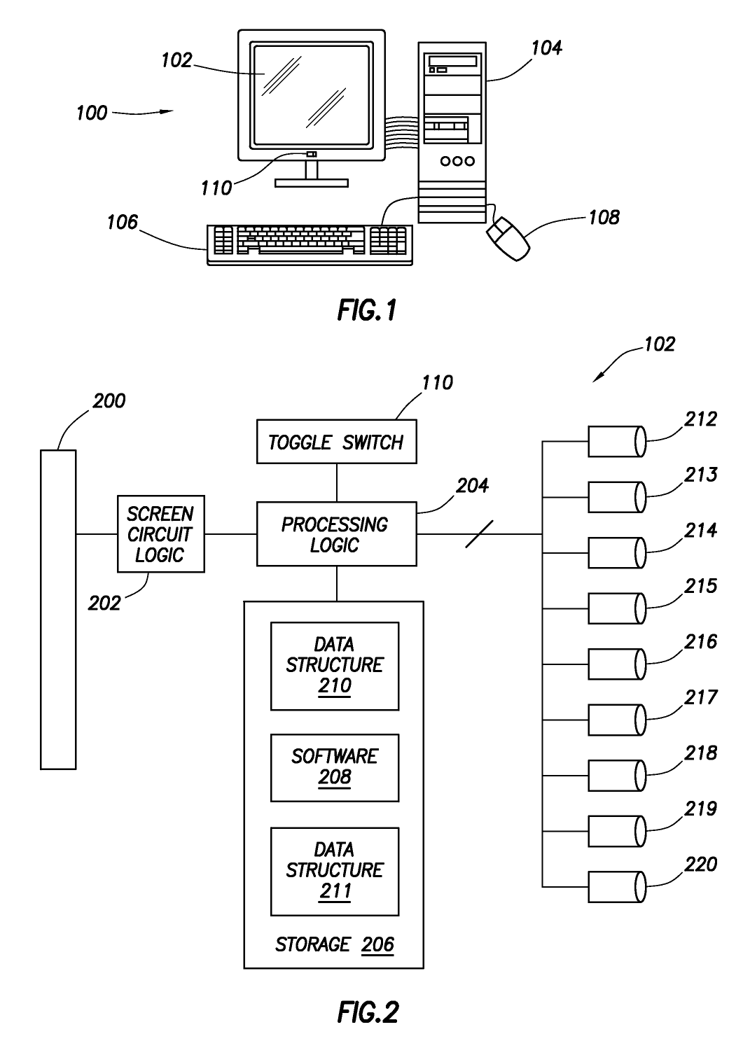

FIG. 1 shows an illustrative computer system 100. The computer system 100 comprises a display 102, a chassis 104, a keyboard 106 and a mouse 108. Other input and/or output devices also may be included. The display 102 receives a plurality of input signals from the chassis 104. Input signals are provided from the chassis 104 to the display 102 via one or more cables. In some embodiments, the display 102 may receive at least a portion of its multiple input signals from two or more different chassis (e.g., half of the input signals may be received from the chassis 104 and half of the input signals may be received from a different electronic device, not shown). The display 102 also comprises user control such as a toggle switch 110, which, when pressed, causes the system 100 to cycle through the multiple ports as described below. In at least some embodiments, the toggle switch 110 is located on an exterior bezel of the display 102 (e.g., adjacent to a power button).

FIG. 2 shows a detailed, illustrative view of the display 102. As shown, the display 102 comprises a screen 200, screen circuit logic 202 that drives the screen 200, processing logic 204 (e.g., a microprocessor) that controls the circuit logic in the display 102, and storage 206 (e.g., random access memory (RAM)) comprising executable code 208, input status data structure 210 and data structure 211. The executable code 208 may be implemented in any suitable form. For example, in some embodiments, the executable code 208 may be embedded on the processing logic 204 in the form of firmware. The display 102 also comprises multiple input ports 212-220. In some embodiments, the ports 212-220 comprise nine discrete video paths. In such embodiments, each of these video paths is assigned a priority level, as described in greater detail below. The signal paths and priorities are listed below, with Priority 1 being of the highest priority and Priority 9 being of the lowest priority among those priorities listed:

Priority 1—DVI-I-1 Digital (Digital Visual Interface—Integrated—1 Digital)

Priority 2—DVI-I-1 Analog (Digital Visual Interface—Integrated—1 Analog)

Priority 3—DVI-I-2 Digital (Digital Visual Interface—Integrated—2 Digital)

Priority 4—DVI-I-2 Analog (Digital Visual Interface—Integrated—2 Analog)

Priority 5—Display Port

Priority 6—HDMI (High Definition Multimedia Interface)

Priority 7—Component video

Priority 8—S video (Separate video)

Priority 9—Composite video

The processing logic 204 couples to the toggle switch 110. The processing logic 204 receives one or more input signals from one or more of the ports 212-220. In turn, the processing logic 204 selects one of the input signals according to predetermined criteria (described below) and provides the selected input signal to the screen circuit logic 202. In turn, the screen circuit logic 202 provides the selected input signal to the screen 200 for display to the end-user(s). The status of each of the ports (e.g., whether each port is active or inactive) is recorded in the data structure 210. The toggle switch 110, when pressed, causes the processing logic 204 to cycle through the various ports 212-220. The data structure 211 indicates the priority, or order, in which the ports are selected by the processing logic 204 when the toggle switch 110 is pressed.

In operation, the processing logic 204 executes the executable code 208. The executable code 208, when executed, causes the processing logic 204 to determine which of the ports 212-220 is currently receiving a display input signal. The term “currently” receiving may refer to the time at which the processing logic 204 performs the determination described above. The processing logic 204 may make such a determination using any of a variety of suitable techniques. In at least some embodiments, the processing logic 204 determines whether a horizontal/vertical synchronization pulse signal is detected on each of the ports 210-222. If such pulse signals are detected on a port, that port is determined to be currently receiving a display input signal. Otherwise, that port is deemed to be inactive.

Regardless of the technique used, if the processing logic 204 determines that a port is currently receiving a display input signal, the processing logic 204 updates the data structure 210 accordingly. Similarly, if the processing logic 204 determines that a port is not currently receiving a display input signal, the processing logic 204 updates the data structure 210 accordingly. The processing logic 204 may make such determinations and subsequently update the data structure 210 on a regular (e.g., preprogrammed) or irregular basis, as desired.

For example, assume the ports 213, 214, and 216-218 each currently receive display input signals, and that the remaining ports do not currently receive display input signals. In such a case, the contents of the data structure 210 would be as shown in FIG. 3. FIG. 3 shows the data structure 210, which comprises a plurality of entries 300, a port field 302 and a status field 304. The data structure 210 cross-references each of the ports 210-220 with a status bit. A status bit of “0” indicates that the corresponding port is not currently receiving a display input signal. A status bit of “1” indicates that the corresponding port is currently receiving a display input signal. The bit scheme may be adjusted as desired.

As previously mentioned, when the toggle switch 110 is pressed (e.g., by an end-user), the processing logic 204 cycles through the various ports 212-220. As each port is selected, that port's display input signal is provided from the port to the screen circuit logic 202 by the processing logic 204. To cycle from one port to the next, the toggle switch 110 may be pressed once and then released, so that each press and release of the toggle switch 110 results in the change from one port to another port. In alternative embodiments, to cycle from one port to the next, the toggle switch 110 may be continuously pressed for a predetermined period of time (e.g., 2 seconds) until the next port is selected. In yet other embodiments, the toggle switch 110 may be pressed once and released, causing the processing logic 204 to cycle through the various ports until a desired port is reached, at which time the toggle switch 110 is pressed and released again, causing the processing logic 204 to stop cycling through the ports.

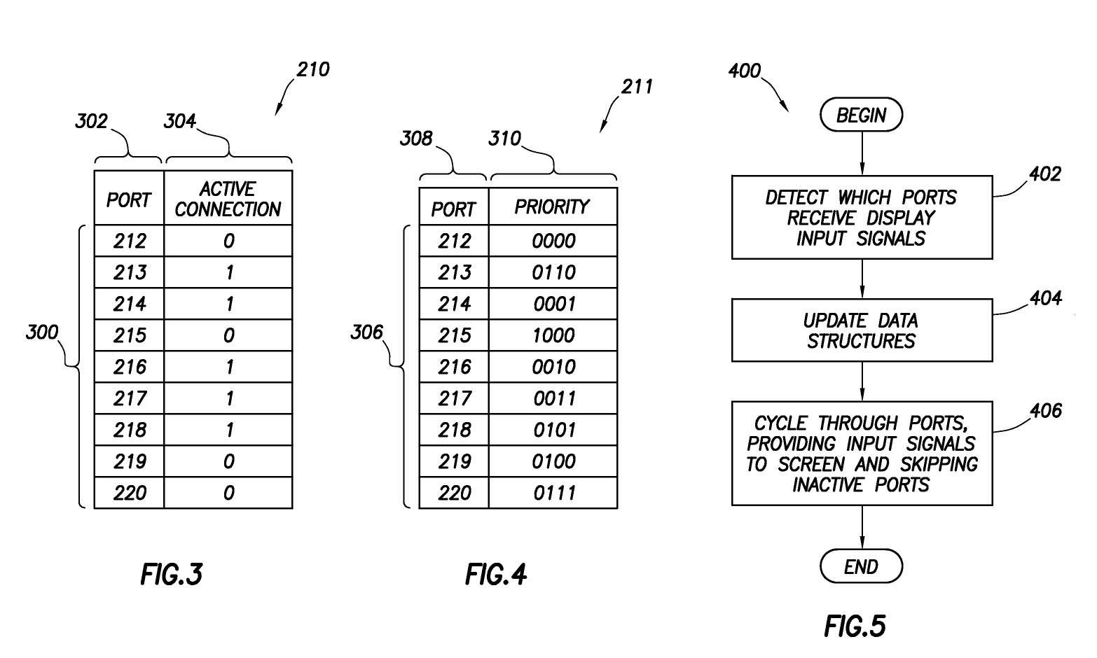

The order in which the system 100 cycles through the multiple ports may be pre-programmed into the data structure 211 (e.g., by a user). Referring to FIG. 4, data structure 211 comprises a plurality of entries 306, a port field 308 and a priority field 310. The data structure 211 cross-references each of the ports 212-220 with one or more bits that indicate a priority level for that port relative to the other ports. For example, port 212 is cross-referenced with priority level “0000,” which is the highest priority level in the data structure 211. In contrast, port 215 is cross-referenced with priority level “1000,” which is the lowest priority level in the data structure 211. Priority level “0001,” associated with port 214, is lower than that of port 212 but higher than that of port 215.

When the system 100 is initially booted, the executable code 208 causes the processing logic 204 to update the data structure 210 based on the most current display input signal information available on the ports 212-220. Once the data structure 210 is updated, the processing logic 204 locates the entry in the data structure 211 that has the highest priority. Because the port 212 has the highest priority, the processing logic 204 refers to the data structure 210 to determine whether the port 212 is currently receiving a display input signal. In the present example, the port 212 is cross-referenced with a “0” bit, indicating that the port 212 is not currently receiving a display input signal. Using the data structure 211, the processing logic 204 then determines that the port 214 has the next highest priority level (“0001”), and so the processing logic 204 uses the data structure 210 to determine whether the port 214 is currently receiving a display input signal. In the present example, the data structure 210 cross-references the port 214 with a “1” bit, indicating that the port 214 is currently receiving a display input signal. Accordingly, the processing logic 204 selects the display input signal on port 214 to be provided to the screen circuit logic 202 for display. In some embodiments, a single data structure may be used in lieu of the data structures 210-211.

When the toggle switch 110 is activated, the processing logic 204 uses the data structure 211 to determine the port with the next highest priority level after the port 214. The data structure 211 indicates that the port 216 has the next highest priority level (“0010”). Accordingly, the processing logic 204 uses the data structure 210 to determine whether the port 216 is currently receiving a display input signal. Because the data structure 210 cross-references the port 216 with a “1” bit, the port 216 is currently receiving a display input signal. Thus, the processing logic 204 ceases allowing the display input signal from the port 214 to pass to the screen circuit logic 202, but instead permits the display input signal from the port 216 to pass to the screen circuit logic 202.

The process described above may be performed as long as, or as many times as, the toggle switch 110 is activated. However, anytime the data structure 210 indicates that a port is not currently receiving a display input signal, the processing logic 204 automatically (i.e., without direct human intervention) skips that port and proceeds to the port with the next highest priority (as indicated in data structure 211). In this way, the amount of time required to cycle through the ports is reduced, because only ports that receive display input signals are selected.

FIG. 5 shows a flow diagram of an illustrative method 400 implemented in accordance with various embodiments. The method 400 begins by detecting which of multiple display input ports are receiving display input signals (block 402). Such detection may be performed, for example, by determining which ports are currently receiving horizontal and vertical synchronization pulses. The method 400 continues by updating one or more data structures with the detection information (block 404). The method 400 continues by cycling through the multiple display ports and providing display input signals from some of the multiple display input ports to display logic (block 406). During the cycling process, those display input ports that are not currently receiving display input signals are skipped. Cycling is performed in an order determined by priority levels assigned to the various ports. During cycling, the determination of whether to skip a display input port is based on whether that port is currently receiving a display input signal (e.g., whether that port is currently receiving—or was receiving, at the time the data structures mentioned above were populated—horizontal and vertical synchronization pulses).

The above discussion is meant to be illustrative of the principles and various embodiments of the present invention. Numerous variations and modifications will become apparent to those skilled in the art once the above disclosure is fully appreciated. For example, although the above techniques are described as being implemented in personal computer displays, they also may be implemented in laptop/notebook displays, mobile communication device displays, etc. It is intended that the following claims be interpreted to embrace all such variations and modifications.

What is claimed is:

1. A system, comprising:
first ports that receive input signals;
one or more second ports that do not receive input signals;
storage comprising a data structure in which said first and second ports are ordered by priority level; and
processing logic that, when selecting an input signal to provide to a display, cycles through the first and second ports in said order;
wherein, when cycling through said ports, the processing logic provides input signals from the first ports to said display and skips over the second ports.

2. The system of claim 1, wherein the system comprises an apparatus selected from the group consisting of a computer display and a mobile communication device.

3. The system of claim 1, wherein the storage further comprises another data structure that cross-references each of the ports to bits that indicate whether that port currently receives a display input signal, and wherein the processing logic skips over the second ports using said another data structure.

4. The system of claim 3, wherein the another data structure cross-references each of the first ports to a common indicator, and the another data structure cross-references each of the second ports to another common indicator, the common indicator and the another common indicator are different.

5. The system of claim 1 further comprising a toggle device, wherein the processing logic cycles through said ports when the toggle device is activated.

6. The system of claim 1, wherein the processing logic determines whether a port is among said first ports by determining whether that port is currently receiving horizontal and vertical synchronization pulses.

7. The system of claim 1, wherein, of the first and second ports, the ports with the highest priority are DVII1 ports, followed by DVII2 ports.

8. The system of claim 7, wherein, of the first and second ports, the ports with the highest priority among the DVII1 ports are DVII1 digital signals, followed by DVII1 VGA signals, and the ports with the highest priority among the DVII2 ports are DVII2 digital signals, followed by DVII2 VGA signals.

9. The system of claim 1, wherein the data structure orders said first and second ports such that a DVI-I-1 Digital port is first, a DVI-I-1 Analog port is second, a DVI-I-2 Digital port is third, a DVI-I-2 Analog port is fourth, a Display Port is fifth, an HDMI port is sixth, a Component video port is seventh, an S video port is eighth, and a Composite video port is ninth, the DVI-I-1 Digital port having a highest priority and the Composite video port having a lowest priority.

10. A system, comprising:
processing logic; and
storage comprising a first data structure and a second data structure, the first data structure cross-references system ports with priority levels, the second data structure cross-references the system ports with status bits that indicate whether the ports are receiving input signals;
wherein, when a toggle device is activated, the processing logic cycles through said system ports in an order determined using the priority levels;
wherein, when the processing logic cycles through said system ports, the processing logic skips over system ports whose status bits indicate that input signals are not being received and provides to display logic input signals from system ports whose status bits indicate that input signals are being received.

11. The system of claim 10, wherein the system comprises a device selected from the group consisting of a personal computer display, a laptop computer display or a mobile communication device display.

12. The system of claim 10, wherein the processing logic updates the second data structure to cross-reference system ports to a common indicator when the processing logic detects horizontal and vertical synchronization pulses on those system ports.

13. The system of claim 10, wherein the first data structure indicates as the highest priority those system ports classified as DVII1 digital signals, followed by DVII1 VGA signals, followed by DVII2 digital signals, followed by DVII2 VGA signals.

14. The system of claim 10, wherein the first data structure cross-references the system ports with the priority levels such that a DVI-I-1 Digital port is of a highest priority, a DVI-I-1 Analog port is of a second-highest priority, a DVI-I-2 Digital port is of a third-highest priority, a DVI-I-2 Analog port is of a fourth-highest priority, a Display Port is of a fifth-highest priority, an HDMI port is of a sixth-highest priority, a Component video port is of a seventh-highest priority, an S video port is of an eighth-highest priority, and a Composite video port is of a ninth-highest priority.

15. The system of claim 10, wherein the toggle device is disposed on a computer display bezel.

16. A method, comprising:
detecting which of multiple display input ports are receiving display input signals;
cycling through the multiple display ports and providing display input signals from some of the multiple display input ports to display logic; and
during the cycling process, skipping those display input ports that are not currently receiving display input signals.

17. The method of claim 16, wherein the multiple display input ports are manufactured on a personal computer display.

18. The method of claim 16, wherein, during the cycling process, cycling through the multiple display ports in a pre-programmed order.

19. The method of claim 16, further comprising activating a toggle device to advance said cycling process.

20. The method of claim 16, wherein said detecting comprises determining which of said multiple display input ports receives horizontal and vertical synchronization pulses.
